(19) United States
(12) Patent Application Publication
(10) Pub. No.: US 2013/0167900 A1
(43) Pub. Date: Jul. 4, 2013

(54) SOLAR CELLS WITH MULTIPLE DYES

(71) Applicants: Peter Holliman, Conwy Gwynedd (GB); Matthew Davies, Bangor Gwynedd (GB); Arthur Connell, Bethesda Gwynedd (GB)

(72) Inventors: Peter Holliman, Conwy Gwynedd (GB); Matthew Davies, Bangor Gwynedd (GB); Arthur Connell, Bethesda Gwynedd (GB)

(21) Appl. No.: 13/702,815

(22) PCT Filed: Jun. 9, 2011
(86) PCT No.: PCT/EP2011/059551

§ 371 Date: Feb. 12, 2013

(30) Foreign Application Priority Data
Jun. 9, 2010 (GB) 1009628.7

(51) Int. Cl. H01G 9/20

(52) U.S. Cl. CPC H01G 9/2077
USPC 136/244; 438/66; 136/256

(57) ABSTRACT

The present invention relates to the field of dye sensitized solar cell, using several dyes and to a method for preparing them rapidly and efficiently focussing on a rapid method for dye sensitization.

### BACKGROUND OF THE INVENTION

1. Field of the Invention

The present invention relates to the field of dye sensitised solar cell using two or more dyes and to a method for preparing them rapidly and efficiently focussing on a rapid method for dye sensitisation.

2. Description of the Related Art

Solar cells are traditionally prepared using solid state semiconductors. Cells are prepared by juxtaposing two doped crystals, one with a slightly negative charge, thus having additional free electrons (n-type semiconductor) and the other with a slightly positive charge, thus lacking free electrons (p-type semiconductor). When these two doped crystals are contacted, extra electrons from the n-type semiconductor flow through the n-p junction to reduce the lack of electrons in the p-type semiconductor. At the p-n junction, charge carriers are depleted on one side and accumulated on the other side thereby producing a potential barrier. When photons produced by sunlight strike the p-type semiconductor, they induce transfer of electrons bound in the low energy levels to the conduction band where they are free to move. A load is placed across the cell in order to transfer electrons, through an external circuit, from the p-type to the n-type semiconductor. The electrons then move spontaneously to the p-type material, back to the low energy level they had been extracted from by solar energy. This motion creates an electrical current.

Typical solar cell crystals are prepared from silicon because photons having frequencies in the visible light range have enough energy to take electrons across the band-gap between the low energy levels and the conduction band. One of the major drawbacks of these solar cells is that the most energetic photons in the violet or ultra-violet frequencies have more energy than necessary to move electrons across the band-gap, resulting in considerable waste of energy that is merely transformed into heat. Another important drawback is that the p-type layer must be sufficiently thick in order to have a chance to capture a photon, with the consequence that the freshly extracted electrons also have a chance to recombine with the created holes before reaching the p-n junction. The maximum reported efficiencies of the silicon-type solar cells are thus of 20 to 25% or lower for solar cell modules due to losses in combining individual cells together.

Another important problem of the silicon-type solar cell is the cost in terms of monetary price and also in terms of embodied energy, that is the energy required to manufacture the devices.

Dye-sensitised solar cells (DSSC) have been developed in 1991 by O'Regan and Grätzel (O'Regan B. and Grätzel M., in Nature, 1991, 353, 737-740). They are produced with low cost material and do not require complex equipment for their manufacture. They separate the two functions provided by silicon: the bulk of the semiconductor is used for charge transport and the photoelectrons originate from a separate photosensitive dye. The cells are sandwich structures represented in FIG. 1 and typically prepared by the steps of:
a) providing a transparent plate (1) typically prepared from glass;
b) coating this plate with a transparent conducting oxide (TCO) (2), preferably with doped tin oxide;
c) applying a paste of metal oxide (3), generally titanium dioxide, to the coated glass plate on the TCO side;
d) heating the plate to a temperature of about 450° C.-500° C. for a period of time of at least one hour;
e) soaking the coated plate of step d) in a dye solution for a period of time of about 24 hours in order to covalently bind the dye to the surface of the titanium dioxide (4);
f) providing another TCO coated transparent plate further coated with platinum (5);
g) sealing the two glass plates and introducing an electrolyte solution (6) between said plates in order to encase the dyed metal oxide and electrolyte between the two conducting plates and to prevent the electrolyte from leaking.

In these cells, photons strike the dye moving it to an excited state capable of injecting electrons into the conducting band of the titanium dioxide from where they diffuse to the anode. The electrons lost from the dye/TiO₂ system are replaced by oxidising the iodide into triiodide at the counter electrode, which reaction is sufficiently fast to enable the photochemical cycle to continue.

The DSSC generate a maximum voltage comparable to that of the silicon solar cells, of the order of 0.8 V. An important advantage of the DSSC as compared to the silicon solar cells is that the dye molecules injects electrons into the titanium dioxide conduction band creating excited state dye molecules rather than electron vacancies in a nearby solid, thereby reducing quick electron/hole recombinations. They are therefore able to function in low light conditions where the electron/hole recombination becomes the dominant mechanism in the silicon solar cells. The present DSSC are however not very efficient in the longer wavelength part of the visible light frequency range, in the red and infrared region, because these photons do not have enough energy to cross the titanium dioxide band-gap or to excite most traditional ruthenium bipyridyl dyes.

The major disadvantage of the DSSC resides in the long time necessary to dye the titanium dioxide nanoparticles: it takes between 12 and 24 hours to dye the layer of titanium dioxide necessary for solar cell applications. Another major difficulty with the DSSC is the electrolyte solution: The cells must be carefully sealed in order to prevent liquid electrolyte leakage.

In order to absorb as broad a spectrum of photons of different wavelengths across the visible region as possible, there are several options. In the prior art, dyes having a broad absorption spectrum have been used. For instance, the ruthenium terpyridyl dye commonly known as “black dye” absorbs light up to a wavelength of 900 nm (M. K. Nazeeruddin, P. Péchy and M. Grätzel, Chem. Commun., 1997, pages 1705-1706). However, this approach can suffer from the disadvantage of the dyes having a moderate absorption coefficient across the broad range of wavelengths. In order to overcome that problem, the possibility of using more than one dye to absorb photons in different parts of the solar spectrum has been suggested. In theory, this can be achieved in one of two ways. Firstly, different ‘sandwiched’ solar cells can be built, as represented in FIG. 3. Several cells, each having a performing dye in a narrow wavelength band can then be stacked. These cells however have a bigger thickness than simple cells and are therefore less transparent. This can be thought of as “tandem” dyeing. Secondly, both dyes can be present within a single titania photo-electrode (FIG. 4) which can be thought of as “cocktail” dyeing. However, this has proved very difficult to achieve in practice because of the need to match the current, the electrolyte and the dye uptake of the different dyes. The few successful attempts to achieve dyeing of a single photo-electrode have required slow dyeing procedures as disclosed for example in Cid et al. (J-J. Cid, J-H. Yum, S—R. Jang, M. K. Nazeeruddin, E. Martinez-Ferrero, E. Palomares, J. Ko, M. Grätzel and T. Torres, Angewandte Chemie International Edition, 2007, 46, 8358-8362) and in Kuang et al. (D. Kuang, P. Walter, F. Nüesch, S. Kim, J. Ko, P. Comte, S. K. Zakeeruddin, M. K. Nazeeruddin and M. Grätzel, Langmuir, 2007, 23, 10906-10909) and/or have used pressure such as supercritical carbon dioxide as disclosed in Inakazu et al. (F. Inakazu, Y. Noma, Y. Ogomi and S. Hayase, Applied Physics Letter, 2008, 93, 093304-1 to 093304-3) or two-phase photo-electrodes as disclosed in Lee et al. (K. Lee, S. Woong Park, M. Jae Ko, K. Kim) and in Park (N. Park, Nature Materials, 2009, 8, 665-671) to selectively dye different parts of the photo-electrode.

There is thus a need to prepare robust solar cells that can be prepared rapidly at reduced cost and have more efficient photon absorption over a broader wavelength range.

### SUMMARY OF THE INVENTION

It is an objective of the present invention to reduce the amount of time necessary to dye the metal oxide.

It is another objective of the present invention to reduce the amount of time necessary to prepare dye sensitised solar cells.

It is also an objective of the present invention to prepare solar panels.

It is yet another objective of the present invention to rapidly sensitise the metal oxide with more than one dye in order to extend the spectral response of the device as widely as possible across the electromagnetic spectrum.

It is a further objective of the present invention to use of multiple dyes to increase the relative efficiency of the device at lower light level.

It is yet a further objective of the present invention to use selected volumes of dye solutions in order to optimise the device's efficiency.

It is also an objective of the present invention to use gel electrolyte in combination with ultra-fast dyeing and ultra-fast multiple dyeing in order to increase the efficiency and lifetime of the dye sensitised solar cells.

In accordance with the present invention, the foregoing objectives are realised as defined in the independent claims. Preferred embodiments are defined in the dependent claims.

### BRIEF DESCRIPTION OF THE DRAWINGS

FIG. 1 is a schematic representation of a dye-sensitised solar cell.

FIG. 2 is a schematic representation of the dye-sensitised solar cell according to the examples of the present invention.

FIG. 3 is a schematic representation of a tandem solar cell using two different dyes.

FIG. 4 is a schematic representation of a “cocktail” dyed solar cell using two different dyes both present within the same photo-electrode

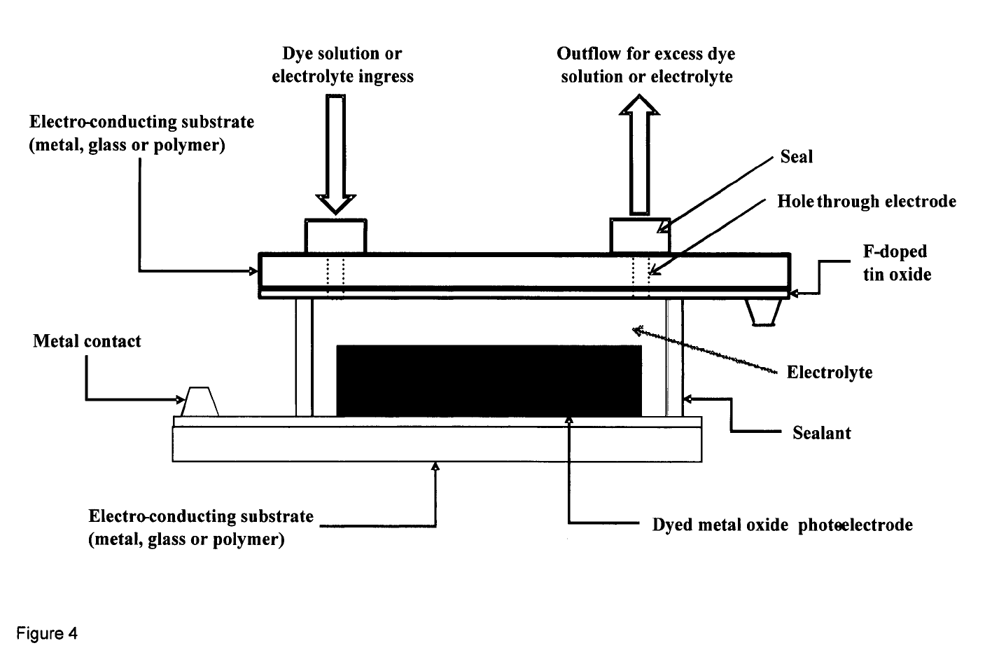

### DESCRIPTION OF THE PREFERRED EMBODIMENTS

The present invention provides a method for reducing the dyeing time of metal oxide by injecting a solution comprising either a combination of dyes or by injecting a series of single or combination dye solutions one after another between the two sealed electrodes of a solar cell device simultaneously with or shortly before the electrolyte.

It is important that the metal oxide surface is in the correct state and does not adsorb water, CO₂ or other gases from the atmosphere before it is dyed. Sealing the electrodes together enables the dye solution to be pumped through the device in the absence of interference. The dyeing time is reduced from a period of time of several hours to a period of time of at most 15 minutes, preferably at most 10 minutes.

Without wishing to be bound by a theory, it is believed that dyeing a thin film of metal oxide takes place in three steps:
a) chemisorption of the dye on the surface of the metal oxide nanoparticles;
b) diffusion of the dye through the solution to the surface of metal oxide nanoparticles;
c) percolation of the dye through the porous metal oxide film.

Chemisorption is a fast process: it involves covalent bonding of the dye molecules to the metal oxide molecules. The dyeing time is thus controlled by diffusion and percolation, percolation being the slowest process. It has surprisingly been found that pumping the dye solution between the two sealed electrodes of the solar cell device considerably shortens the diffusion and percolation times.

Accordingly, the present invention provides a method for preparing dye sensitised solar cells that comprises the steps of:
a) providing a first electrode prepared from an electro-conducting substrate;
b) applying one or more layers of a paste of metal oxide nanoparticles on the conduction side of the substrate;
c) subjecting the coated substrate to a thermal treatment for each layer of metal oxide paste applied;
d) providing a second electrode, the counter-electrode, prepared from a transparent substrate coated with a transparent conducting oxide and additionally coated with platinum or carbon;
e) optionally pre-dyeing the first electrode coated with metal oxide of step b) with a solution comprising one or more dyes in order to covalently bind said dye(s) to the surface of the metal oxide;
f) piercing at least two perforations in the first and/or second electrodes and sealing said electrodes together with glue or with a thermoplastic polymer;
g) pumping two or more solutions comprising the same one or more dyes as those of the pre-dyeing step along with co-sorbents through the holes in the electrodes in order to covalently bind said dye(s) to the surface of the metal oxide;
h) injecting an electrolyte through the holes in the electrodes;
i) sealing the holes in the electrodes with glue or with a thermoplastic polymer;
j) providing an external connection between the two electrodes for electron transport;
   characterised in that dyeing is carried out between the sealed electrodes at a temperature of from 10 to 70° C. with the electrolyte added not more than 10 minutes after the dye, said dyeing being completed in a period of time of no more than 10 minutes and further characterised in that the two or more dyes are introduced simultaneously or consecutively between the sealed electrodes.

Optionally, the dyes are introduced between the sealed electrodes under vacuum.

The first electrode may be transparent or not, preferably, it is transparent. It can be prepared by coating a glass or a polymer substrate having a thickness of from 1 to 4 mm with a conducting oxide. The conducting oxide can be selected from doped zinc oxide or tin oxide doped with indium or fluoride. Preferably it is tin oxide, more preferably it is tin oxide doped with fluorine.

Alternatively, the first electrode may be prepared from a metal such as for example steel, aluminium, titanium or a metal oxide coated metal.

The light can strike the dye-sensitised solar cell either from the metal oxide side (normal illumination) or from the other side (reverse illumination). The efficiency of normal illumination is about twice that of the reverse illumination but it can only be selected if the first electrode is transparent and thus prepared from glass or transparent polymer.

Preferably, the dyes are introduced consecutively.

The nanoparticle paste is preferably prepared from a colloidal solution of metal oxide. The electronic contact between the particles is produced by brief sintering carried out at by thermal treatment at a temperature ranging between 300 and 600° C., preferably between 400 and 500° C. and more preferably at a temperature of about 450° C. The thermal treatment is followed by cooling to a temperature of from 100 to 140° C., preferably to a temperature of about 120° C. The size of the particles and pores making up the film is determined by the size of the particles in the colloidal solution. The internal surface of the film is an important parameter, also determined by the particles' size and by the film's thickness. The pore size must be large enough to allow easy diffusion of the electrolyte. The particle sizes preferably range from 10 to 30 nm, preferably from 12 to 20 nm. The film thickness ranges from 5 to 20 μm, preferably from 9 to 15 μm.

The second electrode is a transparent substrate prepared from glass or polymer. It is coated with a transparent conducting oxide (TCO), preferably with tin oxide, more preferably, with fluorine doped tin oxide. It is preferably further coated with platinum or carbon, more preferably with platinum.

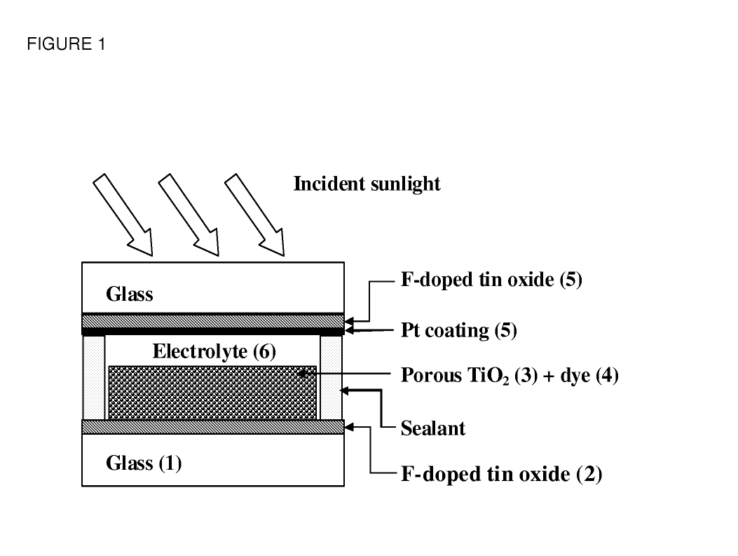

In a preferred embodiment according to the present invention, two perforations are pierced in either the first or in the second electrode: one for injecting the dye(s), cosorbent and electrolyte and the other for the expulsion of excess product if any. The liquids are injected under a small pressure to gently fill the empty space between the metal oxide paste and the second electrode, represented by (6) on FIG. 1.

The combination of dyes is selected from two or more compounds having maximum absorption capability in the visible light range. A photon of light absorbed by the dye promotes an electron into one of its excited states. This excited electron is in turn injected into the conduction band of the metal oxide. The dye must also have the capability to be subsequently reduced by a redox couple present in the electrolyte. Suitable dyes can be selected from ruthenium bipyridyl complexes, ruthenium terpyridyl complexes, coumarins, phthalocyanines, squaraines, indolines, cyanine or triarylamine dyes. The most commonly used dyes are ruthenium bipyridyl complexes.

Surprisingly, when several dyes are used, their mode of introduction in the dye sensitised solar cell has an impact on the cell's resulting efficiency. When a titania photo-electrode is either pre-dyed with one dye solution and then exposed to a second dye solution or exposed to a solution containing two or more dyes for a period of hours and this dyed photo-electrode is then sealed with a counter electrode to make a DSSC device the resulting efficiency of the solar cell is inferior to that of the highest efficiency dye. On the contrary, when the photo-electrode and counter electrode have been sealed together and the dye solutions are then introduced sequentially, one after the other, with little or no interruption, the resulting efficiency of the cell is higher than that of each separate dye. It is also more efficient than a single broad band dye as the absorption of each separate dye is characterised by a narrow and intense absorption peak.

Equally, if the photo-electrode and counter electrode have been sealed together and one solution containing two or more dyes is introduced between the sealed electrodes, simultaneously with or before the electrolyte, the resulting efficiency of the cell is again higher than that of each separate dye.

In a first embodiment according to the present invention, the dyes can be introduced one after the other, followed by the introduction of the electrolyte.

In a second embodiment according to the present invention, the two or more dyes can be introduced continuously one after the other, followed by the introduction of electrolyte using a 2 or more-way valve.

In a third embodiment according to the present invention, the two or more dyes can be introduced simultaneously followed by the introduction of electrolyte in a continuous process using a 2 or more-way valve

The dyeing time is further reduced when several dyes are used consecutively. It is of at most 10 minutes, preferably of at most 5 minutes.

Surprisingly, the order of injection of the dyes has an effect on the device efficiency. It is preferable to inject the dyes in increasing order of efficiency. So the dominant dyes, that is the most efficient dyes, should be injected after the less dominant dyes.

The cosorbents are preferably selected from tertiary butyl pyridine and/or a pH buffer and/or chenodeoxycholic acid and/or one or more ω-guanidinylalkyl acids and/or taurocholic acid. Cosorbents are added to prevent dye aggregation and/or to improve the open circuit voltage, that is the voltage at zero current, V_{oc}, by reducing recombination processes and/or varying the metal oxide conduction band edge to higher or lower potentials and/or to enhance electron lifetime in the TiO₂ and/or to help buffer the dye solution which aids chemisorption of the dye as this is a pH controlled reaction.

The glue or thermoplastic polymers are carefully selected to seal the electrodes and subsequently the holes pierced in the electrodes. Leakage of the electrolyte must be avoided as it reduces the lifetime of the solar cell. Suitable glues are selected from examples such as epoxy resins and the preferred thermoplastic polymers are selected from examples such as Surlyn® (Du Pont). The thickness of the sealant layer is from 20 to 35 μm, preferably of about 25 μm. As the layer of metal oxide is thinner than the layer of sealant, there is an empty space above the metal oxide which should be minimised. It is however not desirable to increase the thickness of the metal oxide because it would increase the percolation time and therefore the dyeing time. The best compromise has been achieved with a sealant thickness of between 20 and 30 μm and a metal oxide thickness of between 10 and 12 μm.

The electrolyte can be advantageously selected from three main groups of compounds:
I) liquid nitrile solvent containing a redox couple and current carriers;
II) gel electrolyte containing a redox couple and current carriers;
III) solid conducting electrolytes.

The most common electrolyte is iodide/triiodide redox electrolyte in a nitrile based solvent. Ionic liquids such as for example imidazolium derivatives, gel electrolytes such as L-valine or solid electrolytes such as OMeTAD-2,2′,7,7′-tetrakis(N,N-di-p-methoxyphenyl-amine)9,9′-spirobifluorene or CuI or CuSCN can also be used as electrolytes.

The electrolyte is introduced between the sealed electrodes simultaneously with or immediately after the solution comprising the dyes and the cosorbents. In this description, immediately after means within at most 10 minutes after the dye(s), preferably at most 5 minutes, more preferably at most 2 minutes and most preferably at most 1 minute. This prevents the metal oxide surface from drying out or being exposed to atmospheric conditions, either of which resulting in reduced device performance.

It has been shown, for example by O'Regan and Grätzel (O'Regan B. and Grätzel B. in Letters to Nature, 353, 1991, 737-740) that nanostructured TiO₂ films used in conjunction with suitable charge transfer dyes are very efficient in converting visible light photons into electric current. They are particularly useful under diffuse daylight, where they perform better than the conventional silicon devices. The spectral distribution of diffuse daylight overlaps favourably with the absorption spectrum of dye-coated TiO₂ film.

The dye-sensitised solar cells can also offer long-term stability.

The present invention also provides dye-sensitised solar cells obtainable by the present method. These solar cells are characterised in that the metal oxide is free of contamination by oxygen and/or carbon dioxide and/or other atmospheric gases.

The present invention further provides dye-sensitised solar panels comprising in whole or in part the individual solar cells produced according to the present invention.

The solar panels can advantageously be prepared from solar cells having different wavelength ranges in order to absorb solar energy in different colour ranges. Because the photo-electrodes are sealed between two electrodes after sintering but before dyeing, the photo-electrodes can be applied, sintered and sealed into any shape. Careful sealing and appropriately drilled holes enable separate cavities to be formed allowing for selective dyeing, such as with different coloured dyes, in order to produce an image which is, at the same time, a working solar cell.

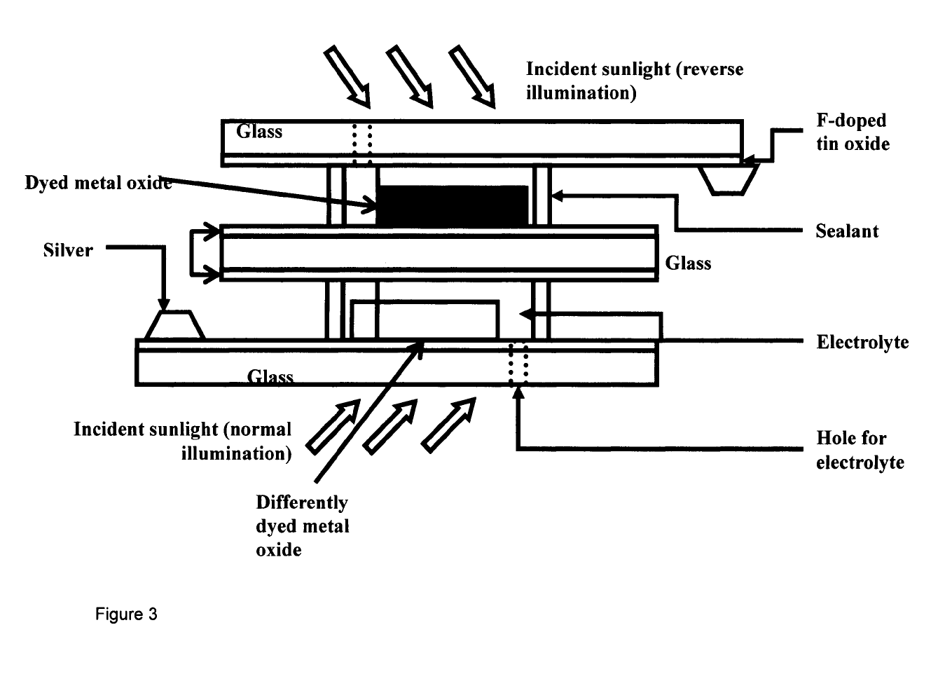

In another embodiment according to the present invention, a hybrid cell using two dyes within a single metal oxid layer is provided in order to achieve better efficiency. In another embodiment according to the present invention, a tandem cell using two dyes, each in a separate metal oxide layer, is provided in order to achieve better efficiency. It is represented in FIG. 3.

The present invention also provides a method for continuously producing dye-sensitised solar cells in the form of a roll or sheet that comprises the steps of:
a) providing a first electrode as a moving roll or sheet of substrate, preferably a roll;
b) providing a first roller coated with metal oxide or a first dispenser for printing said metal oxide continuously on the central portion of the substrate;
c) sintering the printed metal oxide by thermal treatment, followed by cooling;
d) providing a second roller coated with sealant or second dispenser for applying said sealant on the substrate, on the same side as the metal oxide paste and on each side of said metal oxide paste; providing a second electrode as a moving roll or sheet of transparent substrate which has been previously coated with transparent conducting oxide and platinum or carbon and has been previously pierced with holes so as to form perforations;
e) optionally pre-dyeing the metal oxide by applying a dye solution bringing together the first electrode of step d) and the second electrode of step d) and applying pressure and/or heat to seal said two electrodes;
f) injecting the dyes and cosorbent into the perforations provided through the second electrode;
g) injecting the electrolyte through the perforations provided in the second electrode simultaneously with the injection of the dye(s) and cosorbent of step g) or within 10 minutes at the most after the dye(s), preferably at the same time as the dye(s);
h) sealing the perforations in the second electrode;
i) storing a roll or sheet of the dye-sensitised solar cells for subsequent retrieval or cutting the continuous roll of the dye-sensitised solar cells into individual solar cells for storage and subsequent retrieval.

In an alternative embodiment according to the present invention, the sealant can be applied to the second electrode at appropriate spacing to frame the metal oxide present on the first electrode.

The dyes, cosorbent and electrolyte are injected through the holes at a speed carefully selected to gently imbibe the metal oxide coated on the first electrode and achieve dyeing in less than 15 minutes. Increasing the temperature decreases the dyeing time but it is limited to a temperature ranging between room temperature and at most 70 deg C. in order to prevent evaporation of the cosorbents.

The present solar cells thus present several advantages over the prior art solar cells.

The use of multiple dyes increases the relative efficiency at one Sun light intensity and at lower light level with respect to that of single dye devices.

In addition, the relative volumes of dye solutions, as measured by the pumping time for each dye through the device, can be modified in order optimise the efficiency. Thus this invention also covers the use of selected volumes of dye solutions in order to increase the device's efficiency.

The present invention further covers the use of gel electrolyte, preferably in combination with ultra-fast dyeing and ultra-fast multiple dyeing in order to increase the efficiency and the lifetime of the dye sensitised solar cells.

### EXAMPLES

In these examples, current voltage characteristics were measured using simulated AM 1.5 illumination (100 mW cm⁻² or 1 Sun), unless otherwise stated.

### Comparative Examples

Sandwich-type DSC cells devices were prepared following the structure described in FIG. 1. The working photoelectrode was prepared on fluorine tin oxide-coated glass with resistance of 8-15 Ω/cm² from a thin film of opaque/transparent titania having a thickness of 6 to 18 μm, with a working area of 0.72-1.0 cm⁻². The TiO₂ film working electrodes were heated at a temperature of 450° C. for a period of time of 30 minutes and then allowed to cool to 100° C. before being dipped into the dye solution.

Dye solutions containing the di-ammonium salt of cis-bis(4,4′-dicarboxy-2,2′-bipyridine)dithiocyanato ruthenium(II), commonly known as N719, were prepared either in absolute ethanol or in a 1:1 mixture of acetonitrile/tert-butyl alcohol and. absolute ethanol. The concentration used in the ethanol solution was 1 mM and 0.5 mM for the acetonitrile/tert-butanol solvent. The titanium dioxide films were exposed to dye solution for time periods of 1, 5, 8 and 24 h. After dyeing, a thermoplastic polymer gasket (Surlyn®) was placed around the photoelectrode and a second transparent-conducting glass coated electrode with a platinum layer, the counter electrode, was placed on top and the electrodes sealed together at a temperature of 120° C. A commercial liquid electrolyte containing iodine/tri-iodide in nitrile solvent (Dyesol Ltd, Australia) was added through a hole in the counter electrode which was then sealed using thermoplastic polymer (Surlyn®). Table 1 displays the efficiencies and fill factors for comparative cells (0.72 cm²) dyed using N719 for time periods ranging from 1 to 24 h.

TABLE 1

Dyeing time

| | 1 h | 5 h | 8 h | 24 h |
|---|---|---|---|---|
| Fill Factor | 0.32 | 0.52 | 0.53 | 0.52 |
| Efficiency | 0.5 | 3.9 | 4.2 | 4.1 |

### Example According to the Invention

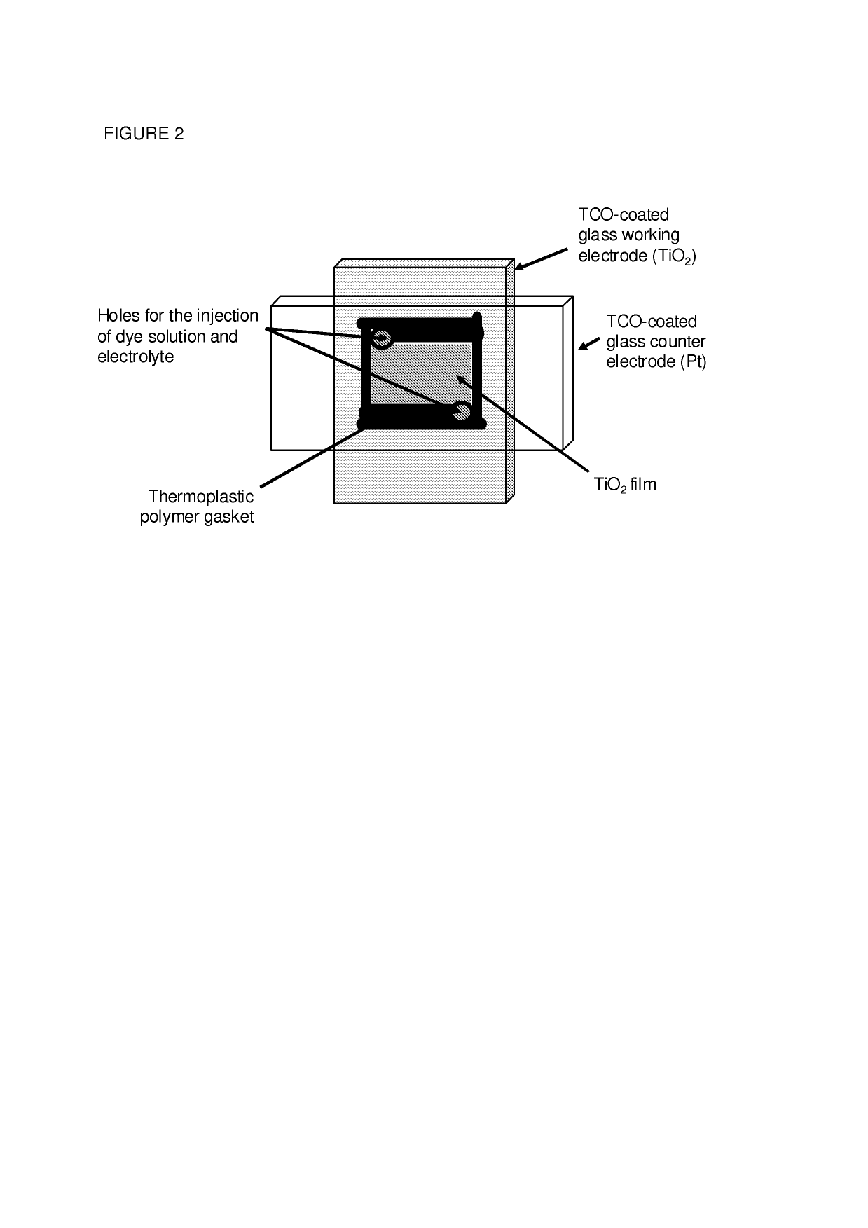

Sandwich-type DSC cells devices were prepared as shown in FIG. 2

The working photoelectrode was prepared on fluorine tin oxide-coated glass (8-15 Ω/cm²) from a thin film of opaque titania having a thickness of 6-12 μm with a working area of 0.78-1.05 cm². The TiO₂ film working electrodes were heated at a temperature of 450° C. for a period of time of 30 minutes. A titanium oxide scattering layer was then deposited onto the working electrodes and the electrodes were again heated to a temperature of 450° C. for a time period of 30 minutes and then allowed to cool to 100° C. before a thermoplastic polymer gasket (Surlyn®) was placed around the photoelectrode. A second transparent-conducting glass coated electrode with a platinum layer, the counter electrode, was placed on top and the electrodes were sealed together at a temperature of 120° C.

Dye solutions containing the di-ammonium salt of cis-bis(4,4′-dicarboxy-2,2′-bipyridine)dithiocyanato ruthenium(II), commonly known as N719, were prepared in a 1:1 mixture of acetonitrile/tert-butyl alcohol and absolute ethanol. The concentration of N719 used was 0.016 mg/l. Dye solutions of the squaraine dye 5-carboxy-2-[[3-[(1,3-dihydro-3,3-dimethyl-1-ethyl-2H-indol-2-ylidene)methyl]-2-hydroxy-4-oxo-2-cyclobuten-1-ylidene]methyl]-3,3-trimethyl-1-octyl-3H-indolium, commonly known as SQ1 were prepared in absolute ethanol at a concentration between 0.01 mM and 5 mM—preferably it is 0.05 mM—either with or without chenodeoxycholic acid, commonly known as CDCA at a concentration between 0 and 10 mM—preferably it is 5 mM. The dye solutions were pumped, individually and sequentially, or as a mixture, through a hole in the counter electrode for a time period of between 5 and 10 minutes at a temperature of 50° C. A liquid electrolyte containing iodine/tri-iodide in nitrile solvent was then added through a hole in the counter-electrode within 5 minutes of the dyeing. The counter electrode was then sealed using thermoplastic polymer (Surlyn®).

### Comparative Examples 1 to 5

### Example 1

2 ml of 0.016 mg/l of N719 dye in 1:1 mixture of acetonitrile and tert-butanol was pumped through the cell over a period of 5 minutes giving rise to a dye uptake of 0.105 mg by the titania film. This gave a cell efficiency of 3.1% and a fill factor of 0.53. Here the electrolyte was added within 5 minutes after the dye.

### Example 2

2 ml of 0.016 mg/l of N719 dye in a 1:1 mixture of acetonitrile and tert-butanol was pumped through the cell over a period of 10 minutes with the addition of vacuum to aid the process, giving rise to a dye uptake of 0.076 mg by the titania film. This gave a cell efficiency of 3.7% and a fill factor of 0.54. Here the electrolyte was added within 5 minutes after the dye.

### Example 3

A titania photo-electrode was submersed in a solution comprised of both N719 and SQ1-CDCA solutions (1:1 v/v) and dyed for a period of 18 hours. The electrode was then removed from the dye solution and the cell was constructed as described above. The resulting DSC device had an efficiency of 5.2% and a fill factor of 0.59—see Table 2.

### Example 4

1 ml of 0.016 mg/l of N719 dye in a 1:1 mixture of acetonitrile/tert-butyl alcohol was pumped through the DSC cell over a period of 5 minutes at a temperature of 50° C. followed by electrolyte. This gave DSC cell efficiency of 6.0% and a fill factor of 0.69.

### Example 5

1 ml of 0.05 mM SQ1-CDCA dye in ethanol was pumped through the DSC cell over a period of 5 minutes at a temperature of 50° C. followed by electrolyte resulting in a DSC device with an efficiency of 3.6% and a fill factor of 0.67.

### Examples 6 to 9 According to the Invention

### Example 6

1 ml of 0.016 mg/l of N719 dye (in a 1:1 mixture of acetonitrile/tert-butyl alcohol) was pumped through the DSC cell over a period of 5 minutes at a temperature of 50° C. followed by the addition of 1 ml of 0.05 mM SQ1-5 mM CDCA dye in ethanol, also pumped for 5 minutes at a temperature of 50° C. The electrolyte was added within 5 minutes after the dye solutions. This gave a DSC cell efficiency of 5.29% and a fill factor of 0.51.

### Example 7

2 ml of a 1:1 v/v mixture of N719 (0.016 mg/l in a 1:1 mixture of acetonitrile/tert-butyl alcohol) and SQ1-CDCA (0.05 mM to 5.0 mM in ethanol) was pumped through the DSC cell over a period of 10 minutes at a temperature of 50° C. The electrolyte was added within 5 minutes after the dye. This gave a cell efficiency of 7.0%.

### Example 8

1 ml of 0.05 mM SQ1 dye (without CDCA) in ethanol was pumped through the DSC cell over a period of 5 minutes at a temperature of 50° C. followed by the addition of 1 ml of 0.016 mg/l of N719 dye (in a 1:1 mixture of acetonitrile/tert-butyl alcohol), also pumped for 5 minutes at a temperature of 50° C. The electrolyte was added within 5 minutes after the dye. This gave a cell efficiency of 4.9% and a fill factor of 0.55.

### Example 9

1 ml of 0.05 mM SQ1 to 5 mM CDCA dye in ethanol was pumped through the DSC cell over a period of 5 minutes at a temperature of 50° C. followed by the addition of 1 ml of 0.016 mg/l of N719 dye (in a 1:1 mixture of acetonitrile/tert-butyl alcohol), also pumped for 5 minutes at a temperature of 50° C. The electrolyte was added within 5 minutes after the dye. This gave a cell efficiency of 7.5% and a fill factor of 0.6.

The results for sun illumination of examples 3 to 9 are summarised in Table 2.

TABLE 2

| | Area | Efficiency | | Current | V_{oc} |
|---|---|---|---|---|---|
| Example | (cm²) | (%) | Fill factor | (mA cm⁻²) | (V) |
| Example 3 | 1.05 | 5.2 | 0.59 | 12.1 | 0.69 |
| Example 4 | 0.85 | 6.0 | 0.69 | 11.1 | 0.79 |
| Example 5 | 0.78 | 3.7 | 0.67 | 8.1 | 0.68 |
| Example 6 | 0.82 | 5.3 | 0.51 | 14.6 | 0.71 |
| Example 7 | 0.92 | 7.0 | 0.58 | 15.7 | 0.77 |
| Example 8 | 0.95 | 4.9 | 0.55 | 12.4 | 0.71 |
| Example 9 | 0.82 | 7.5 | 0.60 | 16.1 | 0.78 |

### Comparative Examples 10 to 12

For passive dyeing, after final sintering of the photo-electrode at a temperature of 450° C. as described above, the photo-electrode was allowed to cool to a temperature of 50-70° C. and then submersed in dye solution for 18 h. Dye solutions containing N719, di-tert butyl pyridyl cis-bis(4,4′-dicarboxy-2,2′-bipyridine)dithiocyanato ruthenium(II), were prepared in a 1:1 mixture of acetonitrile/tert-butyl alcohol (0.5 mM). Further dye solutions were prepared in ethanol (10⁻⁴ M) using the triphenylamine dyes 4-[2-(4-Diphenylamino-phenyl)-vinyl]-benzoic acid]—labelled here as Y1 and 2-cyano-3-{4-[2-(4-diphenylamino-phenyl)vinyl]-phenyl}-acrylic acid—labelled here as R1. The results are displayed in Table 3.

TABLE 3

| | | | Fill | J_{sc}/ | |
|---|---|---|---|---|---|
| Example | Dye | η/% | factor | mA cm⁻² | V_{oc}/V |
| Example 10 | Y1 | 1.2 | 0.65 | 2.64 | 0.70 |
| Example 11 | R1 | 3.4 | 0.63 | 8.43 | 0.65 |
| Example 12 | N719 | 5.6 | 0.56 | 13.10 | 0.77 |

### Examples 13 to 22 According to the Invention

The fast dyeing method was carried out as described previously. The solutions were sequentially pumped for 5 minutes through pre-sealed devices prior to adding the electrolyte in the order shown in Table 4. For Example 21, the Y1 dye was added first and then a mixed solution of N719 and SQ1 was added. The data show that co-sensitization is possible for further combinations of dyes which absorb light in different parts of the solar spectrum to Examples 3 to 9. Examples 21 and 22 further show that ultra-fast tri-sensitization is possible. The solar cells' performances are displayed in Table 4.

TABLE 4

| | | | Fill | J_{sc}/ | |
|---|---|---|---|---|---|
| Example | Dye | η/% | factor | mA cm⁻² | V_{oc}/V |
| Example 13 | Y1 | 2.6 | 0.66 | 6.19 | 0.64 |
| Example 14 | R1 | 4.2 | 0.65 | 9.23 | 0.70 |
| Example 15 | SQ1 | 3.5 | 0.67 | 8.16 | 0.64 |
| Example 16 | N719 | 6.0 | 0.63 | 12.42 | 0.77 |
| Example 17 | Y1 + N719 | 7.2 | 0.61 | 15.13 | 0.78 |
| Example 18 | R1 + N719 | 7.2 | 0.63 | 14.92 | 0.77 |
| Example 19 | Y1 + R1 | 3.2 | 0.57 | 8.89 | 0.63 |
| Example 20 | Y1 + SQ1 | 3.7 | 0.63 | 9.23 | 0.64 |
| Example 21 | Y1 + (N719 + SQ1) | 6.5 | 0.55 | 16.05 | 0.73 |
| Example 22 | Y1 + R1 + SQ1 | 4.4 | 0.51 | 13.56 | 0.64 |

Further dye solutions were prepared in a 1:1 mixture of acetonitrile/tert-butyl alcohol using the organic dyes commonly known as D131 also known as 2-cyano-3-[4-[4-(2,2-diphenylethenyl)phenyl]-1,2,3,3a,4,8b-hexahydrocyclo-pent[b]indol-7-yl]-2-propenoic acid and D149 also known as 5-[[4-[4-(2,2-diphenylethenyl)phenyl]1,2,3,3a,4,8b-hexahydrocyclopent-[b]indol-7-yl]methylene]-2-(3-ethyl-4-oxo-2-thioxo-5-thiazolidinylidene)-4-oxo-3-thiazolidineacetic acid. The D131 and D149 dyes (10⁻⁴ M) were mixed with 5 mM CDCA (1:1 volume).

### Examples 23 to 28

In Examples 23 to 28, the D131 and D149 dye solutions were pumped through sealed glass devices made from a TEC15 photo-electrode and TEC8 counter electrode treated with Dyesol Pt solution with a Surlyn gasket as described previously. The dyes were pumped through either as single dye solutions for 5 minutes in examples 23 to 25 (comparative examples) or sequentially in the order shown in Table 5 in examples 26 to 28, prior to adding the electrolyte. The incident light intensity was then altered as shown in Table 5 showing that co-sensitized devices can perform with relative increases in efficiency at lower light levels.

TABLE 5

| | | Sun | | Fill | J_{sc}/ | |
|---|---|---|---|---|---|---|
| Example | Dye | Level | η/% | factor | mA cm⁻² | V_{oc}/V |
| Example 23 | D149 | 1.0 | 6.3 | 0.51 | 18.0 | 0.68 |
| Example 24 | D149 | 1/3 | 5.3 | 0.53 | 4.9 | 0.61 |
| Example 25 | D149 | 1/10 | 5.4 | 0.44 | 2.3 | 0.53 |
| Example 26 | D131 + D149 | 1.0 | 6.6 | 0.51 | 19.5 | 0.66 |
| Example 27 | D131 + D149 | 1/3 | 7.2 | 0.68 | 5.1 | 0.63 |
| Example 28 | D131 + D149 | 1/10 | 11.2 | 0.70 | 2.6 | 0.62 |

### Examples 29 to 34

In Examples 29 to 34, the D131 and D149 dye solutions were pumped through sealed flexible devices made from a titanium foil photo-electrode and an indium tin oxide-coated polyethylene terephthalate counter electrode which had been platinised using the method described in co-pending patent application WO2011/026812. The devices were sealed using a Surlyn gasket as described above and the dyes were pumped through either as single dye solutions for 5 minutes in comparative examples 29 to 31, or sequentially in the order shown in Table 5 in examples 32 to 34 according to the present invention, prior to adding the electrolyte. The incident light intensity was then altered as shown in Table 6. These examples show that flexible devices can also be ultra-fast co-sensitized. It also shows that flexible devices can perform with relative increases in efficiency at lower light levels.

TABLE 6

| | | Sun | | Fill | J_{sc}/ | |
|---|---|---|---|---|---|---|
| Example | Dye | Level | η/% | factor | mA cm⁻² | V_{oc}/V |
| Example 29 | D149 | 1.0 | 4.3 | 0.66 | 8.9 | 0.74 |
| Example 30 | D149 | 1/3 | 4.1 | 0.73 | 2.3 | 0.73 |
| Example 31 | D149 | 1/10 | 6.2 | 0.72 | 1.3 | 0.69 |
| Example 32 | D131 + D149 | 1.0 | 4.5 | 0.61 | 10.1 | 0.74 |
| Example 33 | D131 + D149 | 1/3 | 4.5 | 0.70 | 2.7 | 0.71 |
| Example 34 | D131 + D149 | 1/10 | 6.8 | 0.71 | 1.4 | 0.68 |

### Examples 35 to 39

In Examples 35 to 39, dye solutions containing either the yellow dye (Y1), the red dye (R1), the ruthenium complex dye (N719) or the squaraine dye (SQ1) were prepared as described previously. In Example 40, a mixed dye solution containing a half squaraine dye (based on half of the dye commonly known as SQ1), the squaraine dye commonly known as SQ1 and the ruthenium dye commonly known as N719 was prepared in a 5:5:90 molar ratio.

The devices in Example 35 to 40 were prepared from a TEC7 photo-electrode and TEC7 counter electrode treated with Dyesol Pt solution with a Surlyn gasket as described previously. The dyes were pumped through either sequentially in the order shown in Table 7 in examples 35 to 39, or as a mixed dye solution in example 40, prior to adding the electrolyte. Table 7 shows the different volumes, of dye solutions pumped through the different devices, represented by pumping time. The resulting device data in Table 7 show that varying the volume of the dye solutions can be used to optimize device performance.

TABLE 7

| | Dye and | Sun | | Fill | J_{sc}/ | |
|---|---|---|---|---|---|---|
| Example | pumping time | level | η/% | factor | mA cm⁻² | V_{oc}/V |
| Example 35 | Y1 (5 min) | 1 | 2.1 | 0.73 | 4.21 | 0.70 |
| Example 36 | R1 (5 min) | 1 | 4.2 | 0.65 | 9.23 | 0.70 |
| Example 37 | Y1 (5 min) + | 1 | 6.2 | 0.71 | 10.84 | 0.80 |
| | N719 (5 min) | | | | | |
| Example 38 | Y1 (1.5 min) + | 1 | 7.0 | 0.73 | 11.96 | 0.81 |
| | N719 (5 min) | | | | | |
| Example 39 | R1 (1.5 min) + | 1 | 6.8 | 0.70 | 12.23 | 0.79 |
| | N719 (5 min) | | | | | |
| Example 40 | Mixed solution | 1 | 6.1 | 0.68 | 11.60 | 0.78 |
| | of half SQ1, | | | | | |
| | SQ1 and N719 | | | | | |
| | (5:5:90) for | | | | | |
| | 5 min | | | | | |

### Examples 41 and 42

In Examples 41 and 42, devices were prepared using the method described previously with a TEC15 working electrode and a platinised TEC8 counter electrode either using a typical liquid electrolyte, based on an organic nitrile solvent as described previously, or with a gel electrolyte using polyvinylidenefluoride-co-hexafluoropropylene (PVDF-HFP supplied by Aldrich) as gelling agent. This gel electrolyte has been reported previously by P. Wang, S. M. Zakeeruddin, J. E. Moser, T. Sekiguchi, M. Grätzel, Nature Materials, 2003, 2, 402-407, and then with the addition of 4-cyano-4′-n-heptyloxybiphenyl liquid crystals by M. Wang, X. Pan, X. Fang, L. Guo, C. Zhang, Y. Huang, Z. Huo, S. Dai, Journal of Power Sources, 2011, 196 (13), 5784-5791.

Examples 41 to 42 displayed in Table 8 show that ultra-fast dyeing can be used by first injecting N719 dye for 5 minutes and then injecting heated gel electrolyte as a viscous solution which then gels within the device void. The gel electrolyte device is thought to have longer working lifetime because of the lower volatility of the gel electrolyte compared to the liquid version.

TABLE 8

| | | | Fill | J_{sc}/ | |
|---|---|---|---|---|---|
| Examples | Dye | η/% | factor | mA cm⁻² | V_{oc}/V |
| Example 41 | N719 + liq. electrolyte | 6.1 | 0.66 | 11.9 | 0.78 |
| Example 42 | N719 + gel electrolyte | 4.9 | 0.53 | 12.4 | 0.78 |

### Examples 43 to 47

In Examples 43 to 47, sealed DSC devices were prepared using TEC7 working electrodes and a platinised TEC7 counter electrodes using two layers of titania colloid sintered at 450° C. with or without the additional layer of larger titania scattering particles as described previously. In these examples, a mixed dye solution containing D131, N719 and SQ1 was ultra-fast dyed for 5 minutes before either liquid electrolyte as described earlier, heated gel electrolyte as described by P. Wang, S. M. Zakeeruddin, J. E. Moser, T. Sekiguchi, M. Grätzel, Nature Materials, 2003, 2, 402-407 or heated gel electrolyte containing 4-cyano-4′-n-heptyloxybiphenyl liquid crystals as described by M. Wang, X. Pan, X. Fang, L. Guo, C. Zhang, Y. Huang, Z. Huo, S. Dai, Journal of Power Sources, 2011, 196 (13), 5784-5791 was added by injection. After adding heated gel electrolyte as a viscous solution, this solution gelled within the device void. Table 9 shows the device efficiency data for these Examples.

Example 44 shows improved device efficiency for a multiply dyed, gel electrolyte device compared to liquid electrolyte in example 43. Liquid crystals specifically 4-cyano-4′-n-heptyloxybiphenyl were added to the electrolyte in example 45. That device however had not aged. Examples 46 and 47 show similar device performances without the additional titania scattering layer whether a gel or liquid electrolyte is used. However, the gel electrolyte device is thought to have longer working lifetime because of the lower volatility of the gel electrolyte compared to the liquid version.

TABLE 9

| | | | | | |
|---|---|---|---|---|---|
| | | | Fill | J_{sc}/ | |
| Examples | Device | η/% | factor | mA cm⁻² | V_{oc}/V |

Scattering layer

| | | | | | |
|---|---|---|---|---|---|
| Example 43 | Liquid electrolyte | 6.8 | 0.64 | 13.3 | 0.80 |
| Example 44 | Gel electrolyte | 7.9 | 0.64 | 15.7 | 0.78 |
| Example 45 | Gel electrolyte with | 7.8 | 0.69 | 14.3 | 0.79 |
| | LC (unaged) | | | | |

No scattering layer

| | | | | | |
|---|---|---|---|---|---|
| Example 46 | Liquid electrolyte | 8.2 | 0.75 | 13.7 | 0.80 |
| Example 47 | Gel electrolyte | 8.1 | 0.71 | 14.4 | 0.79 |

1-13. (canceled)

14. A method for preparing dye sensitized solar cells with multiple dyes, comprising the steps of:
a) providing a first electrode prepared from an electro-conducting substrate;
b) applying one or more layers of a paste of metal oxide nanoparticles on a conduction side of the substrate of step a);
c) thermally treating the coated substrate of step b);
d) providing a second electrode, serving as a counter-electrode, prepared from a transparent substrate coated with a transparent conducting oxide and additionally coated with platinum or carbon;
e) optionally pre-dyeing the first electrode coated with metal oxide with a solution comprising one or more dyes to covalently bind the one or more dyes to the surface of the metal oxide;
f) piercing at least two perforations in the first electrode and/or second electrode and sealing the first and second electrodes together;
g) injecting or pumping two or more dye solutions with a cosorbent through the perforations in the first electrode and/or second electrode to covalently bind the dye to the surface of the metal oxide, wherein each dye solution comprises one or more dyes that can be the same as or different from the one or more dyes of the optional pre-dying solution, and wherein each dye solution comprises at least one different dye;
h) injecting or pumping an electrolyte through the perforations in the first electrode and/or second electrode;
i) sealing the perforations in the first electrode and/or second electrode; and
j) providing an external connection between the first electrode and second electrode for electron transport;
wherein dyeing is carried out between the sealed electrodes at a temperature ranging from 10° C. to 70° C.,
wherein the two or more dye solutions are introduced consecutively between the sealed electrodes,
wherein the dyes are injected in order of increasing efficiency, starting with the least efficient dye, followed by the introduction of the electrolyte not more than 10 minutes after the dyes, and
wherein the dyeing is completed in a period of time of no more than 10 minutes.

15. The method of claim 14, wherein more than one layer of a paste of metal oxide nanoparticles is applied on the conduction side of the substrate of step a), and the coated substrate of step b) is thermally treated after each layer of metal oxide paste is applied.

16. The method of claim 14, wherein the first and second electrodes are sealed together with glue or a thermoplastic polymer.

17. The method of claim 14, wherein the step of injecting or pumping two or more dye solutions through the perforations in the first and/or second electrodes is performed under vacuum.

18. The method of claim 14, wherein the perforations in the first electrode and/or second electrode are sealed with glue or with a thermoplastic polymer.

19. The method of claim 14, wherein the two or more dye solutions are introduced consecutively between the sealed electrodes in a continuous manner using a n-way valve.

20. The method of claim 14, wherein the electro-conducting substrate is a glass or polymer plate coated with a conducting oxide.

21. The method of claim 20, wherein the electro-conducting substrate is transparent.

22. The method of claim 20, wherein the electro-conducting substrate is coated with tin oxide.

23. The method of claim 20, wherein the elector-conducting substrate is coated with fluorine-doped tin oxide.

24. The method of claim 14, wherein the electro-conducting substrate is a metal plate.

25. The method of claim 24, wherein the electro-conducting substrate is a metal plate selected from steel, aluminum, titanium, and a metal oxide coated metal.

26. The method of claim 14, wherein thermally treating the coated substrate of step b) is carried out at a temperature ranging from 300° C. to 600° C. for a period of time of at least one hour.

27. The method of claim 14, wherein the metal oxide paste of step b) is prepared from nanoparticles of titanium dioxide.

28. The method of claim 14, wherein the second electrode comprises a transparent plate prepared from glass or polymer and coated with a transparent tin oxide doped with fluorine and additionally coated with platinum.

29. The method of claim 14, wherein the electrolyte is injected or pumped through the perforations in the first electrode and/or second electrode simultaneously with the dye solutions or at most 10 minutes after the dye solutions.

30. The method of claim 14, wherein the electrolyte is selected from a liquid nitrile solvent containing a redox couple and current carriers, a gel electrolyte containing a redox couple and current carriers, and a solid conducting polymer.

31. The method of claim 14, wherein the dyes are selected from one or more compounds capable of absorbing visible light and injecting electrons from one of said compound's excited state into the conduction band of the metal oxide and further capable of being reduced by a redox couple in the electrolyte.

32. The method of claim 14, wherein the dyes are selected from ruthenium bipyridyl complexes, ruthenium terpyridyl complexes, coumarins, phthalocyanines, squaraines, indolines, and triarylamine dyes.

33. The method of claim 14, wherein the cosorbent is selected from tertiary butyl pyridine, a pH buffer, and chenodeoxycholic acid.

34. A dye sensitised solar cell obtained by the method of claim 14, wherein the metal oxide is free of contamination by oxygen, carbon dioxide, and/or other atmospheric gases, and wherein the efficiency of the solar cell is higher than that of an equivalent solar cell prepared with only the most efficient dye in the combination of dyes.

35. A solar panel comprising a dye sensitized solar cell obtained by the method of claim 14.

36. A method for preparing dye sensitised solar cells with multiple dyes, comprising the steps of:
a) providing a first electrode as a moving roll or sheet of substrate;
b) providing a first roller coated with a metal oxide or a first dispenser for printing the metal oxide continuously on a central portion of the substrate;
c) sintering the printed metal oxide by thermal treatment, followed by cooling;
d) providing a second roller coated with sealant or a second dispenser for applying the sealant on the substrate, on the same side as the metal oxide and on each side of the metal oxide;
e) providing a second electrode as a moving roll or sheet of transparent substrate which has been previously coated with transparent conducting oxide and platinum or carbon and has been previously pierced with holes so as to form perforations;
f) bringing together the first electrode of step b) and the second electrode of step e) and applying pressure and/or heat to seal the two electrodes;
g) injecting or pumping two or more dye solutions each containing different one or more dyes and a cosorbent into the perforations provided through the second electrode;
h) injecting or pumping an electrolyte through the perforations provided in the second electrode simultaneously with the injection of the dye solutions and cosorbent of step g) or within 10 minutes at the most after the dyes;
i) sealing the perforations in the second electrode; and
j) storing a roll or sheet of the dye-sensitised solar cells for subsequent retrieval or cutting the continuous roll of the dye-sensitised solar cells into individual solar cells for storage and subsequent retrieval,
wherein dyeing is carried out between the sealed electrodes at a temperature of from 10 to 70° C.,
wherein the two or more dye solutions are introduced consecutively between the sealed electrodes,
wherein the dyes are injected in order of increasing efficiency, starting with the least efficient dye, and
wherein the electrolyte is added not more than 10 minutes after the dyes, said dyeing being completed in a period of time of no more than 15 minutes.

37. The method of claim 36, wherein the first electrode is a roll.

38. The method of claim 36, wherein the electrolyte is injected or pumped through the perforations at the same time as the dye solutions.

39. The method of claim 36, wherein the two or more dye solutions are introduced consecutively between the sealed electrodes in a continuous manner using a n-way valve.

40. A dye sensitised solar cell obtained by the method of claim 36, wherein the metal oxide is free of contamination by oxygen, carbon dioxide, and/or other atmospheric gases, and wherein the efficiency of the solar cell is higher than that of an equivalent solar cell prepared with only the most efficient dye in the combination of dyes.

41. A solar panel comprising a dye sensitized solar cell obtained by the method of claim 36.
